(19) United States
(12) Patent Application Publication
(10) Pub. No.: US 2003/0184101 A1
(43) Pub. Date: Oct. 2, 2003

(54) Drizzler, a device for decoratively applying toppings to the surface of bakery products

(76) Inventor: Kim Ellen Nelson, Cornell, MI (US)

Correspondence Address: KIM E. NELSON, 3137 CO 426 24RD, CORNELL, MI, 49818, US

(21) Appl. No.: 10/108,111

(22) Filed: Mar. 27, 2002

(51) Int. Cl. B05C 5/00; B25J 1/00

(52) U.S. Cl. 294/1.1; 294/7; 99/494; 294/24; 118/24

(57) ABSTRACT

The object of the present invention is to efficiently drizzle decorative toppings onto baked goods in order to finish them in a decorative manner, while improving their taste. The baking of all types of edible pastries has variously required different modes of sugar coating, glazing, and frosting among which is a common technique called drizzling. In this process amounts of a usually warm, somewhat liquid, or molten topping is essentially dropped by fingers onto the pastries, forming thusly many random looking ridges of flavorful icing.

The present invention is a device which seeks to improve upon the tradition of hand drizzling which has many drawbacks but remains as a prevalent practice in the bakery trades. To this end a simple but effective implement has been invented which, while having only four unsophisticated looking parts, a handle and three spatula-like blades, combines several attributes of a good invention such as filling a practical need, improving upon an existing procedure, saving time, and making a task more productive, cleaner, or pleasant to perform.

### BACKGROUND OF THE INVENTION

In the field of baking the technique known as drizzling has customarily been a hand process. Anyone who has shopped in the bakery department of a typical grocery store is familiar with drizzled products, recognized by their patterned array of frosting lines criss-crossing in various directions. In the past, and as in current practice, the bakery worker has accomplished the above described pattern of icing by dipping the fingers of one hand into a container of liquid topping and therefrom scattering dripped amounts of said topping onto bakery products. Upon cooling and drying this topping solidifies into an attractively interesting pattern of lines which adheres to pastry, thus improving its appearance as well as its flavor.

The present invention supplants this practice with a more safe, efficient, and sanitary method of application. In the present context and for all such here considered intents and purposes the word drizzler will refer to such a tool, utensil, or implememt. No similar invention has been thus far located in patent literature, and from inquiries within the art and practice of baking only one such allusion has been found, that involving anecdotal remarks about an awkward device made of wood only, and which was reportedly of little practical value.

### SUMMARY OF THE INVENTION

A main object of the present invention is to overcome the inadequacies of the current practices in drizzling as now commonly employed among bakery workers. In essence the drizzler in its preferred embodiment mimics, in a simple way—by means of a handle and three appended blades, the shape of spread fingers of the hand as splayed out in the technique of drizzling.

Components of the drizzling art include a confectionary topping such as caramel, a container to hold the topping, a heat source to liquify the topping, items to drizzle such as brownies, a work surface, and a drizzling tool. Heretofore the baker's hand has been the drizzling tool. With the thumb and assorted fingers spread out at about 45 degrees from vertical the baker would dip his or her hand in the topping, get the fingers coated, and maneuver the clinging load of material over the baked goods allowing it to drip into decorative lines and splashes onto the edible wares.

The primary negative aspects of the traditional hand drizzling method which this invention is intended to overcome, avert, or eliminate are three in number as follows: first—discomfort and possible burns to the skin from placing fingers directly in hot liquid, second—health concerns due to unsanitary hand contact with food stuffs, third—inability to function efficiently and to rotate tasks quickly and easily due to the present messy procedure and consequent need for frequent hand washing.

As will be immediately seen my present invention, consisting of only four parts, a handle and three spatula-like blades, is obviously preferrable in use to the primitive procedure just described. This drizzler, at its heart, is an invention which is strikingly and efficiently simple in its function, construction, and appearance.

### BRIEF DESCRIPTION OF THE DRAWINGS

The accompanying drawings show the preferred embodiment of the present invention as envisioned in use, and also provide a visual description for easy and accurate construction of such a drizzler. Included in the drawings are views which include the essential overall form, as well as the shapes and positions of the parts comprising the invention.

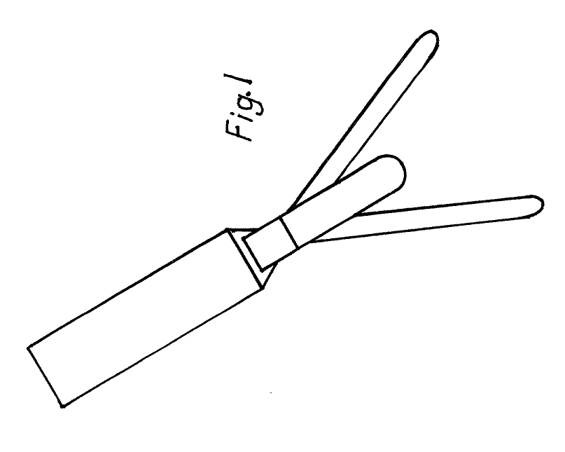

Drawing Sheet 1, including FIG. 1 is a three dimensional perspective of the invention.

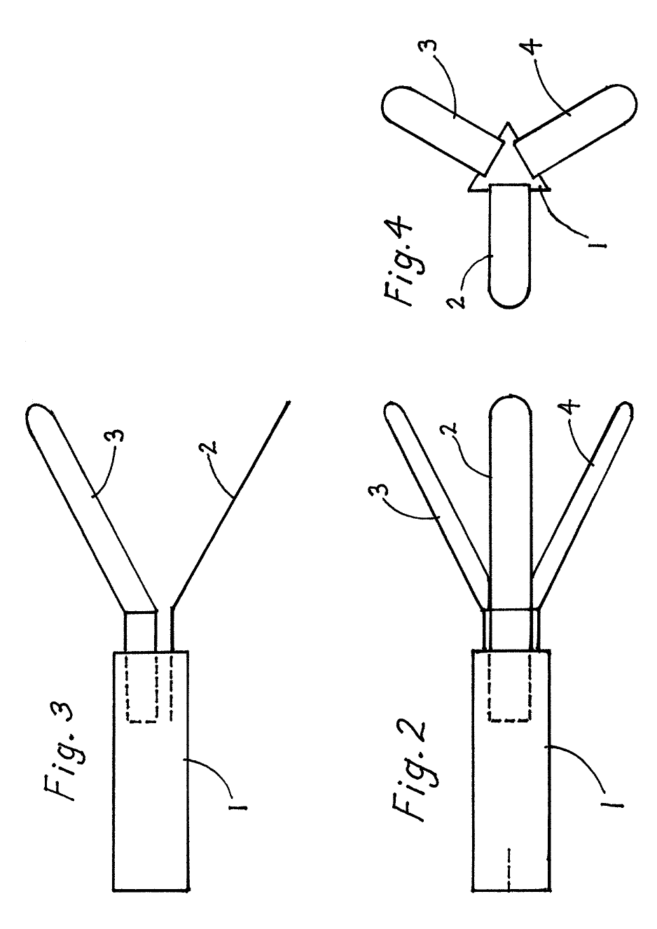

Drawing Sheet 2, including FIGS. 2, 3, and 4 is a series of orthographic or plan views essential to construction of the invention. Certain hidden lines are omitted for clarity.

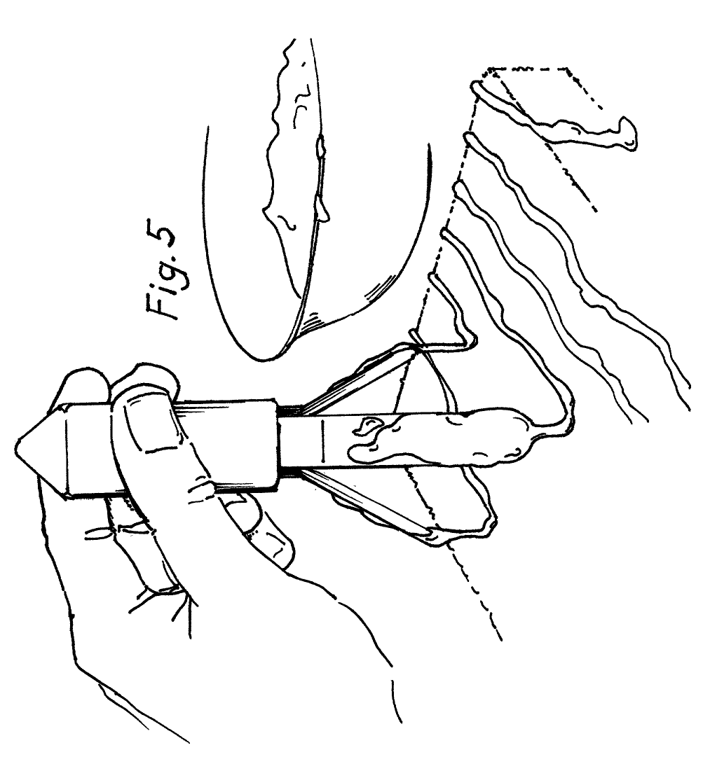

Drawing Sheet 3, including FIG. 5 is an illustration of the invention in practical use.

### DETAILED DESCRIPTION OF THE INVENTION

01. To fully understand the scope and intent of this useful invention one may observe the specific drawings and figures referred to in this detailed description.

02. The drizzler I have invented is a hand held tool comprised of four parts. These parts included a single straight handle and three blades extended from and attached to one end of the handle. The blades are mounted securely by insertion into the handle and shortly after extending therefrom they are bent outwardly at a functional angle of from about 15 degrees to 35 degrees. As may be noted in all the drawings and figures there are three blades mounted in a symmetrical arrangement. This invention therefore, with its four basic parts is configured so as to accomplish a most effective drizzled effect when used in the decoration of bakery items.

03. Referring to Drawing Sheet 2., FIG.3, Part 1 is a handle triangular in cross-section having a lateral width of undefined dimensions but of a general size as would be convenient for grasping by the average sized hand. From 1 ¼″ wide to 2″ in width would be in the range contemplated for prospective manufacture.

04. Referring to Drawing Sheet 2., FIGS. 1 and 2, Part 1, this same handle would have a longitudinal dimension as again would be convenient for grasping by the average sized hand. From 3 ½″ to 5 ½″ in length would be in the range contemplated for prospective manufacture.

05. The handle portrayed in the present drawings possesses no special character in the art of handle making except that a three sided embodiment of same has proven to be comfortable in gripping and simultaneously efficient in assembly in combination with the plurality of blades shown. It has, however, further advantages which will be addressed later in the text. Naturally the rounding off of sharp corners would be a consideration in handle design and would be necessary for user comfort at all handle edges and corners.

06. There are a plurality of blades which protrude from the working end of the handle and which are firmly affixed to the handle by insertion into it. These same blades which are three in number in the preferred embodiment are advantageously bent so as to attain the purpose of the invention, namely to pick up by adhesion an amount of properly liquefied material, when said blades are dipped into same. Therafter this same liquid material after being loaded as above, is allowed through gravity, to drip, or drizzle onto the surface of baked goods with an artistically controlled technique.

07. These blades, as shown in all the drawings and figures and which shape is best understood by observing Drawing Sheet 2, FIGS. 2, 3, and 4, Part 2, may be understood to be generally planar in nature and possessing an outward bend in an area near connection to the handle. The angle of this outward bending, referencing Part 2 in FIG. 3, would fall within certain functional limits of from perhaps 15 degrees to 35 degrees from the longitudinal axis of the blade itself and similarly from the handle, this general range being sufficient to define the scope and intention of the device.

07. The general size of the herein described blades in length, width, and thickness, and other characteristics would be as prove advantageous for the intended use. Therefore a thin planar material possessing a smooth surface, as well as significant strength and flexibility would be desirable. Blades from 5″ to 7″ long, by from ½″ to 1″ wide, and from 1/64″ to 1/16″ thick would be in the range contemplated for prospective manufacture.

08. The preferred materials of manufacture would include stainless steel for the blades because of strength, durability, flex- ibility, ease of cleaning, attractiveness, and appropriateness of use with edible products, and molded plastic for the handle because of permanent blade fixture, strength, ease of construction, cleanability, attractiveness, and comfort in gripping during extended periods of use.

09. In the context of the present drawings it may be understood that Part 2, Part 3, and Part 4 are essentially one and the same in terms of their composition, size, shape, function, and other material respects given the triangular symmetry of the invention.

10. The front, or working, ends of said blades in the present illustrations are of a generally curved shape such as semi-circular, for safety and convenience. The rear, or tang, ends of said blades in the present illustrations are of a generally squared-off shape for insertion and anchoring in the handle.

11. In the preferred embodiment and for purposes of mass production of such a drizzler the blades would ideally be imbedded permanently in the handle matrix. This could be accomplished by casting or molding processes with plastics and would be especially successful with modification to the tangs of the respective blades such as making them perforated, ridged, bent or otherwise configured and adapted for anchoring purposes. Prototypes could easily be developed for such purposes by those skilled in the art.

12. Since various modifications and subtleties of construction may occur to those skilled in the art it is not intended that the exact portrayal of the present invention provided heretofore shall encompass all such variations but shall instead define the general spirit and scope of the invention.

13. The functional value of the present invention has been tested in an actual working situation. For this purpose I have made a prototype of wood and stainless steel which is currently being used daily with great success in the bakery of a large grocery store.

14. The use of molded plastic and stainless steel in mass production would in combination produce an attractive looking utensil, matching much of current design found in contemporary cookware.

15. An advantageous property of the present invention would include its ability to resist rolling or being dislodged from its place of rest between uses when resting upon its side.

16. Another advantageous property of the present invention would include its ability to be grasped such that in its triangular symmetry any grip is comfortable and correct.

17. Another advantageous property of the present invention is that the three sided handle offers a more positive gripping and slip resistant surface to grasp.

18. Still another advantageous property of the present invention would include its ability to stand on its working end without tipping over while at rest on a table top or in a container of frosting.

19. A still further advantageous property of the present invention would be that it could easily be configured for hanging on a rack or other out of the way storage by insertion of an eye hook into the handle's end or by a perforation molded into the handle.

20. Yet another advantageous property of the present invention would include its ease of cleaning and maintenance as typical of any well-conceived hand tool or kitchen utensil.

21. A further advantageous property of the present invention would include its economy in cost of manufacture or price of purchase enabling more wide spread usage.

22. A still further advantageous property of the present invention would include its applicability to other than the culinary arts, as for example in fine arts painting, interior decorating, or ceramics where it could be used to drizzle various paints or clay slips.

1. What is claimed is a decorating tool comprising a handle for gripping, a plurality of spatula-like blades for procurring a liquid decorating medium, and this same plurality of blades for depositing said decorating medium, the handle being substantially straight, and the blades extending from said handle and which through bending are canted symmmetrically and axially away from said handle at a suitable functional angle.

2. What is further claimed is a handle as described in claim 1 which is substantially triangular in cross section, having substantially rounded corners and edges, this said handle possessing indentations in its leading face for the purpose of inserting and thereby anchoring a plurality of narrow blades which are deployed through bending at a substantial angle greater than 1 degree but less than 90 degrees from the lengthwise axis of the device and which in their entirety form the working end of the device.

3. What is further claimed is a plurality of blades as in claims 1 and 2 said blades being three in number in the preferred embodiment and which are generally planar in nature and comprised of a substantially thin, narrow, strong, flexible, and smooth material as they extend from, and through bending, angle away from the center of the device.
